(19) United States
(12) Patent Application Publication
(10) Pub. No.: US 2019/0009463 A1
(43) Pub. Date: Jan. 10, 2019

(54) BUILD SURFACE HEAT CONTROL

(71) Applicants: Xavier VILAJOSANA, Sant Cugat del Valles (ES); Sergio PUIGARDEU, Sant Cugat del Valles (ES); Alejandro Manuel PENA, Sant Cugat del Valles (ES); David RAMIREZ, Sant Cugat del Valles (ES); Pol FORNOS, Sant Cugat del Valles (ES); HEWLETT-PACKARD DEVELOPMENT COMPANY, L.P., Houston, TX (US)

(72) Inventors: Xavier Vilajosana, Sant Cugat del Valles (ES); Sergio Puigardeu, Barcelona (ES); Alejandro Manuel De Pena, Barcelona (ES); David Ramirez, Barcelona (ES); Pol Fornos, Barcelona (ES)

(73) Assignee: HEWLETT-PACKARD DEVELOPMENT COMPANY, L.P., Houston, TX (US)

(21) Appl. No.: 16/065,464

(22) PCT Filed: Mar. 30, 2016
(86) PCT No.: PCT/EP2016/056961

§ 371 Date: Jun. 22, 2018

(51) Int. Cl. B29C 64/153; B29C 64/165; B29C 64/386

(52) U.S. Cl. CPC B29C 64/153; B33Y 50/02; B29C 64/386; B29C 64/165

(57) ABSTRACT

There is provided a method and apparatus for controlling heat to a build surface. A thermal profile over the build surface is determined. The determined thermal profile over the build surface is compared with an expected thermal profile over the build surface. Based on the comparison, the determined thermal profile over the build surface or the expected thermal profile over the build surface is selected to control an amount of heat provided by a heating module to the build surface.

### BACKGROUND

Additive manufacturing systems that generate three-dimensional objects on a layer-by-layer basis are convenient for producing three-dimensional objects.

Some additive manufacturing techniques may generate a three-dimensional object through the solidification of a build material. In examples of such techniques, build material may be supplied in a layer-wise manner and the solidification method includes heating the layers of build material to cause melting in selected regions. The amount of heat supplied to a build material can be controlled and adjusted. Example of other additive manufacturing techniques include chemical solidification systems.

### BRIEF DESCRIPTION OF DRAWINGS

For a more complete understanding, various examples will now be described below with reference to the accompanying drawings in which:

FIG. 1 is a block diagram of an apparatus according to an example;

FIG. 2 illustrates a block diagram of the apparatus in use in a system according to an example;

FIG. 3 is an illustration of a process employed according to an example;

FIG. 4 is an illustration of an example interface according to an example; and

FIG. 5 is a block diagram of a computing system according to an example.

### DETAILED DESCRIPTION

Some examples described herein provide an apparatus and method for controlling the heat provided to a build surface. The build surface may, for example, be a layer of build material on a build support. The control of heat can involve increasing an amount of heat provided to the build surface, decreasing an amount of heat provided to the build surface, or maintaining an amount of heat provided to the build surface to mitigate overheating or under-heating of the build surface. In some examples, the heat may be provided to the whole of the build surface. In other examples, the heat may be provided selectively to a point on the build surface or to an area of the build surface. In some examples, the same amount of heat may be provided over the build surface. In other examples, different amounts of heat may be provided over the build surface (i.e. different points or areas of the build surface may be provided with different amounts of heat).

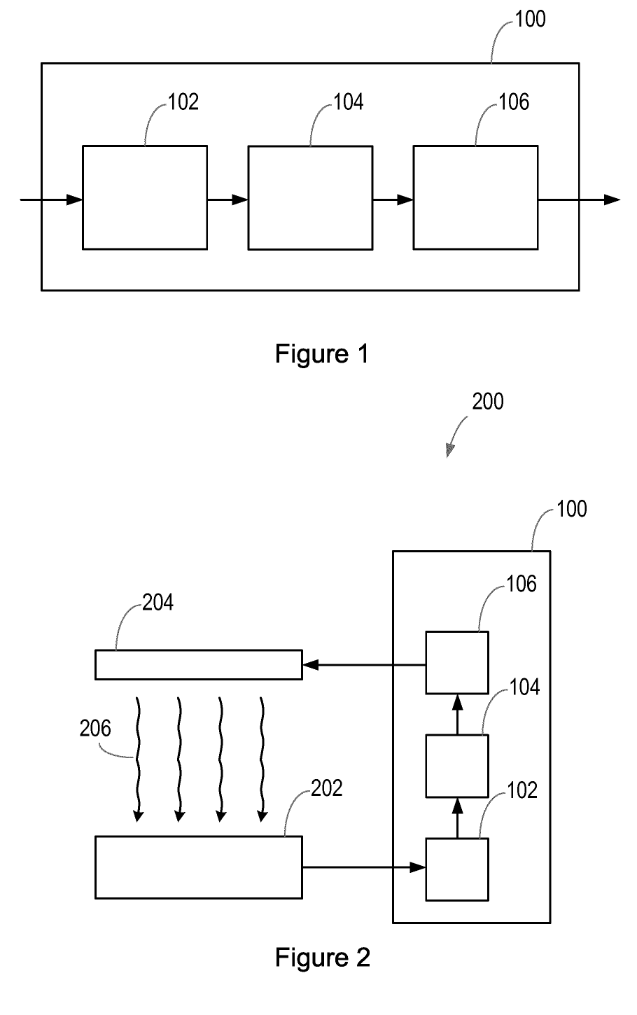

The present subject-matter is further described with reference to FIGS. 1, 2, 3, 4 and 5. It should be noted that the description and figures merely illustrate principles of the present subject-matter. It is thus understood that various arrangements may be devised that, although not explicitly described or shown herein, embody the principles of the present subject-matter. Moreover, all statements herein reciting principles and examples of the present-subject matter, as well as specific examples thereof, are intended to encompass equivalents thereof.

FIG. 1 illustrates a block diagram of an apparatus 100 according to an example. The apparatus 100 comprises a sensor module 102 to determine (or obtain) a thermal profile over a build surface. In some examples, the thermal profile can comprise a temperature over a build surface. In other examples, the thermal profile can comprise a power supplied to a heating module or energy source (not shown) providing heat to the build surface. In some examples, the thermal profile can comprise a temperature over a build surface and a power supplied to a heating module or energy source (not shown) providing heat to the build surface. For example, the sensor module 102 may sense a temperature over the build surface and determine an associated power supplied to the heating module providing heat to the build surface based on the sensed temperature over the build surface (i.e. the power supplied to the heating to achieve, or that would generate, the sensed temperature over the build surface). The heating module may be part of the apparatus 100 or a separate heating module.

The sensor module 102 may comprise a set of sensors. The sensors may be any sensor capable of sensing temperature such as a thermal imaging device, an infrared (IR) sensor, a thermal camera, or the like. Although examples of sensors are provided, it will be understood that other sensors can be used for sensing temperature. In some examples, a combination of different sensors can be used for sensing temperature.

The apparatus 100 comprises a processing module 104 to compare the obtained thermal profile over the build surface with an expected (or predefined) thermal profile over the build surface. The expected thermal profile over the build surface may be stored in a memory unit (not shown), which can be part of the apparatus 100 or can be a separate memory unit. The expected thermal profile may be loaded at the beginning of a print process or at another time during a print process and may be used throughout the print process. The expected thermal profile may be obtained in a calibration phase.

The expected thermal profile may be in the form of a model, map, look-up table, or similar, indicative of an expected (or predicted) thermal profile. In one example, where the expected thermal profile comprises an expected temperature over the build surface 202, the thermal profile may be in the form of a temperature profile (such as a heat map or a two-dimensional array of temperature points). The temperature profile may be a temperature distribution over the build surface 202 (i.e. a spatial temperature distribution), a temperature distribution over the build surface over time (i.e. a temporal temperature distribution), or both, where the time may be a predetermined period of time, a time taken to apply a layer of build material to the build surface 202 or a time taken to apply a predetermined number of layers of build material to the build surface. In some examples, the thermal profile may be in the form of a set of expected temperature values over the build surface 202 based on a power supplied to the heating module 204 to heat the build surface 202. In another example, where the expected thermal profile comprises an expected power supplied to the heating module providing heat to the build surface, the thermal profile may be in the form of list of expected power values.

In another example, where the thermal profile comprises an expected temperature over the build surface and an expected power supplied to the heating module providing heat to the build surface, the thermal profile may be in the form of a look-up table comprising expected temperature values and associated expected power values. For example, the look-up table may comprise expected temperature values at set times (such as throughout a print process) and corresponding values of power supplied to the heating module 204 to achieve those expected temperature values at those times (i.e. pairs of temperature and power values at given times). The look-up table may also comprise an indication of the locations on the build surface 202 for the expected temperature values. The amount of values in the look-up table can be customisable and may depend on the degree of control to be achieved. Although examples for the form of the thermal profile have been provided, it will be understood that other forms and combinations can be used.

The apparatus 100 comprises a control module 106 to control an amount of heat provided to the build surface by a heating module using either the sensed thermal profile over the build surface or the expected thermal profile over the build surface, depending on a result of the comparison. As mentioned previously, the heating module may be part of the apparatus 100 or a separate heating module.

FIG. 2 illustrates a block diagram of the apparatus 100 in use in a system 200 according to an example. The system 200 comprises a build surface 202 in the form of a print bed to support a build material. The system 200 comprises a heating module 204 (i.e. an energy source) to provide heat 206 to the build surface 202. The heating module 204 may be any kind of lamp (such as a lamp that emits in the visible range, ultraviolet range or infrared range), a medium wave infrared heater, a ceramic heater, a resistive heater, a convective heater, or the like. Although examples of heating modules are provided, it will be understood that other heating modules or energy sources (such as microwaves) can be used for providing heat 206 to the build surface 202. In some examples, the heating module 204 may be in the form of a set (or array) of heating modules to provide heat 206 over the build surface 202. The set (or array) of heating modules 204 may be of the same type or may be a combination of different heating modules.

The control module 106 of the apparatus 100 controls the amount of heat 206 provided to the build surface 202 by the heating module 204. The heat 206 provided to the build surface 202 by the heating module 204 can be used to change or adjust the temperature distribution over the build surface 202. For example, the heating module 204 may provide heat 206 to the build surface 202 to generate a uniform temperature distribution over the build surface 202 (i.e. a stable and homogenous temperature over the build surface 202) or a non-uniform temperature distribution over the build surface 202. In one example, a uniform temperature distribution over the build surface 202 may be generated by the heating module 204 providing a non-uniform heat 206 across the build surface 202 (such as by a set of heating modules 204 over the build surface 202 being provided with different amounts of power) to compensate for heat losses that vary across the build surface. In another example, a non-uniform temperature distribution over the build surface 202 may be generated by the heating module 204 providing different amounts of heat 206 to different areas of the build surface 202 (such as by a set of heating modules 204 over the build surface 202 being provided with different amounts of power).

The sensor module 102 of the apparatus 100 obtains the thermal profile over the build surface 202. In one example, the sensor module 102 is in the form of a single sensor capable of sensing temperature (i.e. a heat or thermal sensor). In another example, the sensor module 102 is in the form of a set of sensors (i.e. the sensor module 102 may comprise multiple sensors) capable of sensing temperature. The set of sensors may be of the same type or may comprise a combination of different types of sensors capable of sensing temperature. In this example, each sensor of the set of sensors may acquire a temperature measurement (or reading) of an area of the build surface 202. The areas of the build surface 202 may be overlapping (or almost overlapping) where the sensors acquire a temperature measurement for various areas or non-overlapping where the sensors acquire a temperature measurement for individual areas. From the temperature measurements of the areas of the build surface 202 acquired by the set of sensors, the sensor module 102 can generate the thermal profile over the build surface 202. In other words, a thermal profile is built using input from the sensors. As described earlier, the thermal profile may be of any form and may also comprise power values for the heating module obtained from the temperature measurements.

Where the thermal profile comprises a temperature distribution (for example, in the form of a thermal map), the temperature distribution may show a uniform temperature over the build surface 202 (for example, where different areas of the build surface 202 have the same or a similar temperature) or a non-uniform temperature over the build surface 202 (for example, where different areas of the build surface 202 have different temperatures).

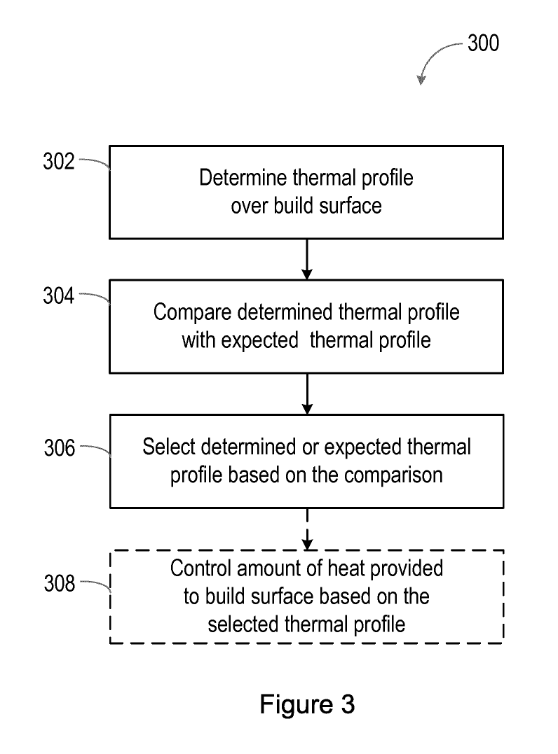

FIG. 3 illustrates a process 300 employed according to an example. The process 300 may be triggered at the beginning of a print process and/or at another time during the print process and may be used throughout the print process. In one example, the process 300 is triggered at set time intervals such as by use of a timer. In another example, the process 300 is triggered each time a layer of build material is applied to the build surface 202 or may be triggered each time a predefined number of layers of build material are applied to the build surface 202.

At block 302 of FIG. 3, a thermal profile over a build surface 202 is determined (or obtained). The sensor module 102 of the apparatus 100 determines (or obtains) the thermal profile. In one example, determining a thermal profile over the build surface 202 may comprise determining a temperature profile over the build surface 202. The temperature profile may be a temperature distribution over the build surface 202 (i.e. a spatial temperature distribution), a temperature distribution over the build surface over time (i.e. a temporal temperature distribution), or both. In some examples, the sensor module 102 may measure (i.e. sample or read) the temperature of the build surface 202 continuously. In other examples, the sensor module 102 may measure (i.e. sample or read) the temperature of the build surface 202 at set time intervals (for example, at start-up and at set time intervals thereafter), each time a layer of build material is applied to the build surface 202, or each time a predefined number of layers of build material are applied to the build surface 202. The temperature of the build surface 202 may be sampled to determine a thermal profile comprising determined values of temperature over the build surface 202 that correspond to values of the expected temperature of the build surface 202. For example, the temperature of the build surface 202 may be sampled at times for which an expected temperature value is identified in a database (such as from a look-up table or the like).

In another example, as part of determining (or obtaining) the thermal profile at block 302, an associated power supplied to the heating module 204 providing heat 206 to the build surface 202 may be determined based on the determined temperature profile over the build surface 202. The power supplied to the heating module 204 may be determined for each sampled temperature value.

At block 304, the determined thermal profile over the build surface 202 is compared with an expected thermal profile over the build surface 202. In other words, the difference between the thermal profile over the build surface 202 and the expected thermal profile over the build surface 202 is determined. The processing module 104 of the apparatus 100 performs this comparison. This may involve comparing the determined temperature profile over the build surface 202 with the expected temperature profile over the build surface 202, comparing the determined power supplied to the heating module 204 with the expected power supplied to the heating module 204, or both. In other words, this may involve determining the difference between the determined temperature profile over the build surface 202 and the expected temperature profile over the build surface 202, determining the difference between the determined power supplied to the heating module 204 and the expected power supplied to the heating module 204, or both. Where temperature measurements are acquired for different areas of the build surface 202, the points in time where the comparison between the determined temperature profile and the expected temperature profile is performed may be the same time for each area, a different time for some of the areas or a different time for each of the areas over the build surface 202.

In one example, a sampled temperature value of the build surface 202 is compared to a corresponding expected temperature value in a look-up table or similar. In other words, the time at which the temperature is sampled is identified in the table and the sampled temperature value is compared with the corresponding expected temperature value in the table for that time. In another example, a determined power value supplied to the heating module 204 is compared to a corresponding expected power value in a look-up table or similar. In other words, the time at which the temperature is sampled is identified in the table and the power determined from that sampled temperature is compared with the corresponding expected power value in the look-up table for that time.

In one example, the determined thermal profile comprises determined values of temperature over the build surface 202 and the expected thermal profile comprises corresponding expected values of temperature over the build surface 202. In this example, the determined values of temperature over the build surface 202 are compared with the corresponding expected values of temperature over the build surface 202 to determine a difference between the determined values of temperature over the build surface 202 and the corresponding expected values of temperature over the build surface 202. In another example, the determined thermal profile comprises determined values of power supplied to the heating module 204 and the expected thermal profile comprises corresponding expected values of power supplied to the heating module 204. In this example, the determined values of power supplied to the heating module 206 are compared with the corresponding expected values of power supplied to the heating module 204 to determine a difference between the determined values of power supplied to the heating module 204 and the corresponding expected values of power supplied to the heating module 204. In other examples, the comparison may include comparing temperature values and comparing power values.

At block 306, the determined thermal profile over the build surface 202 or the expected thermal profile over the build surface 202 is selected, based on the comparison (i.e. based on the result of block 304), to control an amount of heat 206 provided to the build surface 202 by the heating module 204. In other words, the determined difference between the determined thermal profile over the build surface 202 and the expected thermal profile over the build surface 202 is used to select which of the thermal profiles (i.e. the determined or expected thermal profile) to use for controlling the heat 206 provided by the heating module 204 to the build surface 202. As described previously, the thermal profile may comprise a temperature over a build surface 202, the thermal profile may comprise a power supplied to the heating module 204 providing heat 206 to the build surface 202, or the thermal profile may comprise a temperature over a build surface 202 and a power supplied to the heating module 204 providing heat 206 to the build surface 202. Based on the comparison, a power to apply to the heating module 204 is determined (as will be described later).

In one example, the determined difference between the determined thermal profile over the build surface 202 and the expected thermal profile over the build surface 202 may be compared to a threshold and, based on whether the determined thermal profile is the same as the expected profile or the determined difference is above or below the threshold, the thermal profile is selected. The control module 106 of the apparatus 100 selects the thermal profile to control the amount of heat 206 provided to the build surface 202.

If the determined thermal profile over the build surface 202 differs from the expected thermal profile over the build surface 202 by more than the threshold, the expected thermal profile over the build surface 202 is selected to control the amount of heat 206 provided to the build surface 202. On the other hand, if the determined thermal profile over the build surface 202 is the same as or differs from the expected thermal profile over the build surface 202 by less than the threshold, the determined thermal profile over the build surface 202 is selected to control the amount of heat 206 provided to the build surface 202.

In an example where a determined temperature profile over the build surface 202 is compared with an expected temperature profile over the build surface 202, selecting based on the comparison comprises selecting the determined temperature profile over the build surface 202 or the expected temperature profile over the build surface 202 based on the comparison to control an amount of heat 206 provided by the heating module 204 to the build surface 202. In other words, the determined difference between the temperature profile over the build surface 202 and the expected temperature profile over the build surface 202 is used to select which temperature profile (i.e. the determined or expected temperature profile) to use for controlling the heat 206 provided by the heating module 204 to the build surface 202.

For example, if the determined temperature profile over the build surface 202 differs from the expected temperature profile over the build surface 202 by more than a threshold, selecting based on the comparison comprises selecting the expected temperature profile over the build surface 202 to control the amount of heat 206 provided to the build surface 202. On the other hand, if the determined temperature profile over the build surface 202 is the same as or differs from the expected temperature profile over the build surface 202 by less than the threshold, selecting based on the comparison comprises selecting the determined temperature profile over the build surface 202 to control the amount of heat 206 provided to the build surface 202.

The amount of heat 206 provided by the heating module 204 to the build surface 202 can be controlled by setting a power supplied to the heating module 204 providing heat 206 to the build surface 202 based on the selected temperature profile. In other words, it is determined whether to provide the heating module 204 with a determined power (obtained from a determined temperature profile) or an expected power (such as a corresponding expected power identified in a look-up table or similar).

In an example where a determined power supplied to the heating module 204 is compared with an expected power supplied to the heating module 204, selecting based on the comparison comprises selecting to supply the heating module 204 with the determined power supplied to the heating module 204 or the expected power supplied to the heating module 204 based on the comparison to control the amount of heat 206 provided by the heating module 204 to the build surface 202. In other words, the determined difference between the power supplied to the heating module 204 and the expected power supplied to the heating module 204 is used to select which power (i.e. the determined or expected power) to use for controlling the heat 206 provided by the heating module 204 to the build surface 202.

For example, if the determined power supplied to the heating module 204 differs from the expected power supplied to the heating module 204 by more than a threshold, selecting based on the comparison comprises selecting the expected power supplied to the heating module 204 to control the amount of heat 206 provided to the build surface 202. On the other hand, if the determined power supplied to the heating module 204 is the same as or differs from the expected power supplied to the heating module 204 over the build surface 202 by less than the threshold, selecting based on the comparison comprises selecting the determined power supplied to the heating module 204 to control the amount of heat 206 provided to the build surface 202.

The amount of heat 206 provided by the heating module 204 to the build surface 202 can be controlled by setting a power supplied to the heating module 204 providing heat 206 to the build surface 202 to the selected power. In other words, it is determined whether to provide the heating module 204 with a determined power or an expected power (such as a corresponding expected power identified in a database, e.g. from a look-up table or similar).

At block 308, the process 300 may comprise controlling the amount of heat 206 provided to the build surface 202 based on the selected thermal profile (i.e. by the power set based on the selected temperature profile or the power set to the selected power). The heating module 204 provides the heat 206 to the build surface 202. In this way, the amount of heat 206 provided to the build surface 202 may be controlled based on the selected thermal profile by controlling the amount of power (or energy) provided to the heating module 204 (for example, a set of lamps) that is heating the build surface 202. In one example, the power may be controlled using a pulse width modulation (PWM) technique. However, it will be understood that other techniques for controlling (for example, changing or adjusting) power can be used.

In one example, a layer of build material may be applied to the build surface 202 and further layers of build material may also be applied to the build surface 202. The process 300 (including blocks 302, 304, 306, and 308) is repeated for each layer of build material that is applied to the build surface 202 or each time a predefined number of layers of build material are applied to the build surface 202. In this example, the expected thermal profile over the build surface 202 is the same for each applied layer of build material. In other words, the thermal behaviour of a layer is identical to the thermal behaviour of a subsequent layer, the power behaviour of a layer is identical to the power behaviour of a subsequent layer, or the thermal and power behaviour of a layer is identical to the thermal and power behaviour of a subsequent layer.

Where the expected thermal profile (or temperature map) comprises a set of expected temperature values over the build surface 202 based on a power supplied to the heating module 204 to heat the build surface 202 in this example, the number of expected temperature values in the set may be based on the power supplied to the heating module 204 to heat the build surface 202 and a time taken for applying a layer of build material to the build surface 202. For example, if the time taken for applying a layer of build material to the build surface 202 is 10s, the set may contain 1000 elements (i.e. samples) indicating expected temperature and power values to be applied every 10 ms during printing of the layer, 100 elements indicating expected temperature and power values to be applied every 100 ms during printing of the layer, and so on.

The process 300 may also comprise generating an object by applying layers of build material to the build surface 202 and repeating the process 300 (including blocks 302, 304, 306, and 308) for each layer of build material that is applied to the build surface 202 or each time a predefined number of layers of build material are applied to the build surface 202, as described above.

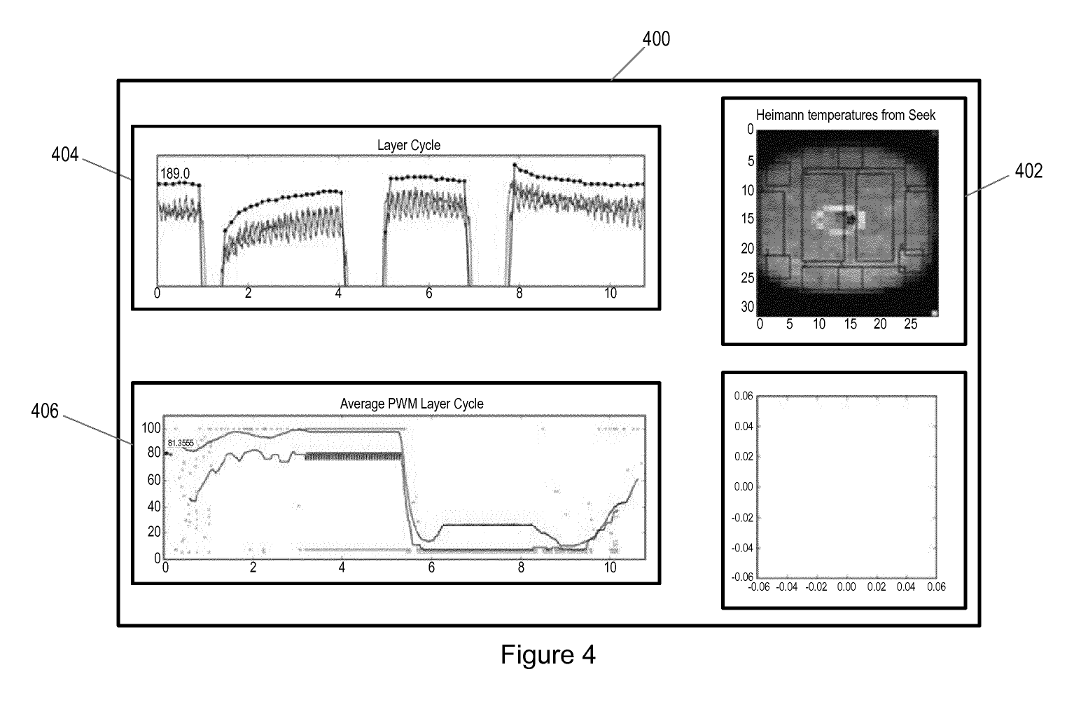

FIG. 4 is an illustration of an interface (i.e. a display) 400 according to an example. The interface 400 may be part of the apparatus 100 or a separate interface module. The interface 400 renders (or displays) the data and information acquired from the process 300. For example, in this example, the user interface 400 renders a thermal map 402 acquired from an infrared imaging array with overlaid sample control zones, a graphical output 404 of temperature readings in the control zones as a function of time, and a corresponding graphical output 406 of a power profile modulation of an array of lamps providing heat to build surface that follows a predetermined temperature profile.

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. Build material may be deposited, for example on a build surface or print bed and processed layer by layer, for example within a fabrication chamber manner.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a coalescing agent (also termed a ‘coalescence agent’ or ‘fusing agent’) may be selectively distributed onto portions of a layer of build material in a pattern derived from data representing a slice of a three-dimensional object to be generated (which may for example be generated from structural design data). The coalescing agent may have a composition which absorbs energy such that, when energy (for example, radiation is applied to the layer, the build material coalesces and solidifies to form a slice of the three-dimensional object in accordance with the pattern. In other examples, coalescence may be achieved in some other manner.

In addition to a coalescing agent, in some examples, a print agent may comprise a detailing (i.e. coalescence modifier) agent, which acts to modify the effects of a coalescing agent for example by reducing or increasing coalescence or to assist in producing a particular finish or appearance to an object, and such agents may therefore be termed detailing agents. A colouring agent, for example comprising a dye or colorant, may in some examples be used as a coalescing agent or a detailing agent, and/or as a print agent to provide a particular colour for the object.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

According to the present disclosure, there is provided a non-transitory machine-readable storage medium encoded with instructions executable by a processor. The machine-readable storage medium comprises instructions to perform at least part of the method described herein. The method may be used in conjunction with any other programs.

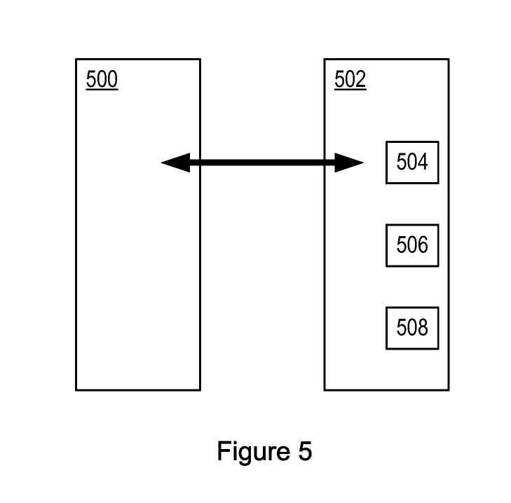

FIG. 5 is a block diagram of a computing system according to an example. There is provided a non-transitory machine-readable storage medium 502 encoded with instructions 504, 506, 508, executable by a processor 500. The machine-readable storage medium comprises instructions to perform at least part of the method described herein. For example, the machine-readable storage medium 502 comprises instructions 504 to measure a thermal profile over a build surface, instructions 506 to compare the measured thermal profile over the build surface with an expected thermal profile over the build surface and instructions 508 to, based on the comparison, select the measured thermal profile over the build surface or the expected thermal profile over the build surface to control heating of the build surface.

Examples in the present disclosure can be provided as methods, systems or machine-readable instructions, such as any combination of software, hardware, firmware or the like. Such machine-readable instructions may be included on a machine-readable storage medium (including but is not limited to disc storage, CD-ROM, optical storage, etc.) having machine-readable program code therein or thereon.

The present disclosure is described with reference to flow charts and/or block diagrams of the method, apparatus and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realised by machine-readable instructions.

The machine-readable instructions may, for example, be executed by a general purpose computer, a special purpose computer, an embedded processor or processors of other programmable data processing devices to realise the functions described in the description and figures. For example, a processing apparatus or processor may execute the machine-readable instructions. Thus, functional modules of the apparatus and devices (such as the sensor module, the processing module, the control module and the heating module) may be implemented by a processor executing machine-readable instructions stored in a memory, or a processor operating in accordance with instructions embedded in logic circuitry. The term “processor” is to be interpreted broadly to include a processing unit, central processing unit (CPU), application-specific integrated circuit (ASIC), logic unit, programmable gate array, etc. The methods and functional modules may all be performed by a single processor or divided amongst several processors.

Such machine-readable instructions may also be stored in a machine-readable storage that can guide the computer or other programmable data processing devices to operate in a specific mode.

Such machine-readable instructions may also be loaded onto a computer or other programmable data processing devices, so that the computer or other programmable data processing devices perform a series of operations to produce computer-implemented processing, thus the instructions executed on the computer or other programmable devices provide a means for realising functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit and scope of the present disclosure. It should be noted that the above-mentioned examples illustrate rather than limit what is described herein, and that those skilled in the art will be able to design many alternative implementations without departing from the scope of the appended claims. For example, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
determining a thermal profile over a build surface;
comparing the determined thermal profile over the build surface with an expected thermal profile over the build surface; and
based on the comparison, selecting the determined thermal profile over the build surface or the expected thermal profile over the build surface to control an amount of heat provided by a heating module to the build surface.

2. A method according to claim 1, wherein the thermal profile comprises a temperature over a build surface and a power supplied to the heating module providing heat to the build surface.

3. A method according to claim 1, wherein determining a thermal profile over a build surface comprises determining a temperature profile over the build surface, wherein the temperature profile is a temperature distribution over the build surface or a temperature distribution over the build surface over time.

4. A method according to claim 3, wherein comparing comprises:
comparing the determined temperature profile over the build surface with an expected temperature profile; and
wherein selecting comprises:
based on the comparison, selecting the determined temperature profile over the build surface or the expected temperature profile over the build surface to control an amount of heat provided by the heating module to the build surface.

5. A method according to claim 4, wherein:
if the determined temperature profile over the build surface differs from the expected temperature profile over the build surface by more than a threshold, selecting based on the comparison comprises:
selecting the expected temperature profile over the build surface to control the amount of heat provided to the build surface, and
if the determined temperature profile over the build surface is the same as or differs from the expected temperature profile over the build surface by less than the threshold, selecting based on the comparison comprises:
selecting the determined temperature profile over the build surface to control the amount of heat provided to the build surface.

6. A method according to claim 5, wherein the amount of heat provided by the heating module to the build surface is controlled by setting a power supplied to the heating module providing heat to the build surface based on the selected temperature profile.

7. A method according to claim 3, comprising determining an associated power supplied to the heating module providing heat to the build surface based on the determined temperature profile over the build surface.

8. A method according to claim 7, wherein comparing comprises:
comparing the determined power supplied to the heating module with an expected power supplied to the heating module; and
wherein selecting comprises:
based on the comparison, selecting to supply the heating module with the determined power supplied to the heating module or the expected power supplied to the heating module to control the amount of heat provided by a heating module to the build surface.

9. A method according to claim 8, wherein:
if the determined power supplied to the heating module differs from the expected power supplied to the heating module by more than a threshold, selecting based on the comparison comprises:
selecting the expected power supplied to the heating module to control the amount of heat provided to the build surface, and
if the determined power supplied to the heating module is the same as or differs from the expected power supplied to the heating module over the build surface by less than the threshold, selecting based on the comparison comprises:
selecting the determined power supplied to the heating module to control the amount of heat provided to the build surface.

10. A method according to claim 1, comprising:
applying a layer of build material to the build surface; and
repeating the method of claim 1 for each applied layer of build material,
wherein the expected thermal profile over the build surface is the same for each applied layer of build material.

11. A method according to claim 1 comprising:
generating an object by applying layers of build material to the build surface and repeating the method of claim 1 for each layer of build material.

12. An apparatus comprising:
a sensor module to obtain a thermal profile over a build surface;
a processing module to compare the obtained thermal profile over the build surface with an expected thermal profile over the build surface; and
a control module to control an amount of heat provided to the build surface by a heating module using the obtained thermal profile over the build surface or the expected thermal profile over the build surface, depending on a result of the comparison.

13. An apparatus according to claim 12 comprising:
the heating module to provide heat to the build surface, wherein the control module controls the amount of heat provided to the build surface by the heating module.

14. An apparatus according to claim 12, wherein the sensor module comprises a set of sensors, each sensor acquiring a thermal profile measurement for an area of the build surface, and wherein the sensor module is to generate the thermal profile over the build surface from the thermal profile measurements of the areas of the build surface acquired by the set of sensors.

15. A non-transitory machine-readable storage medium encoded with instructions executable by a processor, the machine-readable storage medium comprising:
instructions to measure a thermal profile over a build surface;
instructions to compare the measured thermal profile over the build surface with an expected thermal profile over the build surface; and
instructions to, based on the comparison, select the measured thermal profile over the build surface or the expected thermal profile over the build surface to control heating of the build surface.
